(19) United States
(12) Patent Application Publication
(10) Pub. No.: US 2022/0324635 A1
(43) Pub. Date: Oct. 13, 2022

(54) X-RAY TUBE PACKING DEVICE

(71) Applicant: CANON ELECTRON TUBES & DEVICES CO., LTD., Otawara-shi (JP)

(72) Inventor: Yuuichi MURAKOSHI, Utsunomiya (JP)

(73) Assignee: CANON ELECTRON TUBES & DEVICES CO., LTD., Otawara-shi (JP)

(21) Appl. No.: 17/808,882

(22) Filed: Jun. 24, 2022

Related U.S. Application Data
(63) Continuation of application No. PCT/JP2020/046659, filed on Dec. 15, 2020.

(30) Foreign Application Priority Data
Dec. 26, 2019 (JP) 2019-236454

(51) Int. Cl. B65D 85/30; H05G 1/02; F16M 11/20; B65D 19/44; B65D 77/04

(52) U.S. Cl. CPC B65D 85/30; H05G 1/02; F16M 11/2021; B65D 19/44; B65D 77/04; F16M 2200/024

(57) ABSTRACT

According to one embodiment, an X-ray tube packing device packs an X-ray tube. The X-ray tube packing device includes an installation stand, an X-ray tube mounting portion to which the X-ray tube is mounted, and a rotation mechanism provided on the installation stand and that rotatably supports the X-ray tube mounting portion. The rotation mechanism changes the X-ray tube from a posture at the time of packing to a posture at the time of installation, which is different from the posture at the time of packing and is the posture at the time of placing the X-ray tube on the installation stand after unpacking.

### CROSS-REFERENCE TO RELATED APPLICATIONS

This application is a Continuation Application of PCT Application No. PCT/JP2020/046659, filed Dec. 15, 2020 and based upon and claiming the benefit of priority from Japanese Patent Application No. 2019-236454, filed Dec. 26, 2019, the entire contents of all of which are incorporated herein by reference.

### FIELD

Embodiments described herein relate generally to an X-ray tube packing device.

### BACKGROUND

In a case of transporting X-ray tubes to a predetermined installation site, an X-ray tube packing device is used for packing the X-ray tubes.

The X-ray tubes have an optimal posture (orientation) when packed (transported) in terms of strength, shock, and vibration against loads applied from the outside during transportation. On the other hand, at the time of installation after unpacking at the installation site, a different posture from the time of packing is often preferred from the viewpoint of mounting the X-ray tubes on a device of another party into which the X-ray tube is to be incorporated. For example, in the case of a medical X-ray tube device, the other party device is a frame or the like of an X-ray computed tomography scanner (hereinafter referred to as an X-ray CT scanner).

In such cases where the posture of the X-ray tube needs to be changed, an operator changes the posture while holding the X-ray tube by hand.

However, when the posture of the X-ray tube is changed, the moment the position of the center of gravity of the X-ray tube moves to a position that is easily affected by gravity, an unexpected rotation of the X-ray tube occurs, causing the X-ray tube to topple over or fall, thereby causing the X-ray tube to malfunction or break. Therefore, the posture of the X-ray tube needs to be changed while holding the X-ray tube by multiple operators. Thus, it is not easy to change the posture of the X-ray tube.

### BRIEF DESCRIPTION OF THE DRAWINGS

FIG. 1 is a perspective view of an X-ray tube packing device showing an embodiment at the time of packing.

FIG. 2 is a perspective view of the above X-ray tube packing device at the time of unpacking.

FIG. 3 is a perspective view of the above X-ray tube packing device in a state where an X-ray tube is rotated to a posture of when being installed.

FIG. 4 is a perspective view of an installed state of an X-ray tube by the above X-ray tube packing device.

FIG. 5 shows a rotation prevention state of a rotation prevention mechanism of the above X-ray tube packing device, where (a) is a front view of an operation part and (b) is a side view of a mechanism part.

FIG. 6 shows a rotatable state of a rotation prevention mechanism of the above X-ray tube packing device, where (a) is a front view of an operation part and (b) is a side view of a mechanism part.

### DETAILED DESCRIPTION

In general, according to one embodiment, there is provided an X-ray tube packing device for packing an X-ray tube. The X-ray tube packing device comprises: an installation stand; an X-ray tube mounting portion for mounting the X-ray tube; and a rotation mechanism that is provided on the installation stand, and rotatably supports the X-ray tube mounding portion. The rotation mechanism changes the X-ray tube from a posture at a time of packing to a posture at a time of installation, which is different from the posture at the time of packing and is the posture at the time of placing the X-ray tube on the installation stand after unpacking.

Embodiments of the present invention will be described below with reference to the accompanying drawings.

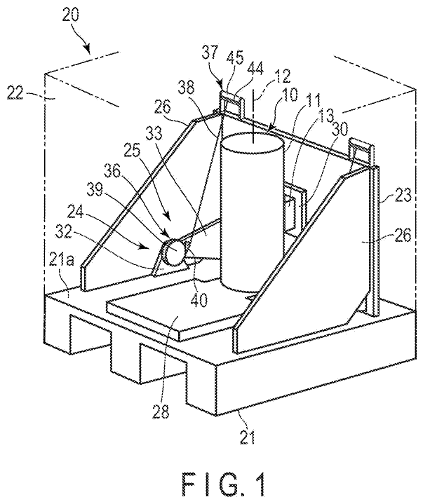

FIG. 1 shows an X-ray tube 10 to be packed. The X-ray tube is, for example, a rotation anode X-ray tube. The X-ray tube 10 is provided with a tube container 11, which is a vacuum tube, accommodating therein a cathode that emits thermal electrons, an anode target that emits X-rays when thermal electrons from the cathode collide with it, a rotation mechanism that rotates the anode target, and the like. The tube container 11 is cylindrical and has a tube axis 12. On a side surface of the tube container 11 perpendicular to the tube axis 12 is provided a radiation port portion 13 that emits X-rays. The rotation mechanism rotates the anode target around a rotation axis along the tube axis 12 of the tube container 11.

FIG. 1 shows an X-ray tube packing device 20 that packs the X-ray tube 10 to transport it to a predetermined installation site. The X-ray tube packing device 20 comprises an installation stand 21 which is a base plate, an outer packing portion 22, an X-ray tube mounting portion 23, a rotation mechanism 24, a rotation prevention mechanism 25, and a fixing portion 26. Note that, in FIG. 1, a part of the outer packing portion 22 is omitted, and an inner packing configuration is shown.

The installation stand 21 has a rectangular shape and is formed pallet-like to enable transportation by a forklift. On the installation stand 21, an installation portion 28 for placing the X-ray tube 10 in a posture at the time of installation is disposed. The installation portion 28 is formed, for example, of an elastic material.

The outer packing portion 22 covers and packs the periphery of the X-ray tube 10 that is mounted on the installation stand 21.

The X-ray tube mounting portion 23 is provided in the form of a plate. The X-ray tube mounting portion 23 has a mounting base portion 30 on which the radiation port portion 13 of the X-ray tube 10 is mounted. A female screw is provided in the radiation port portion 13, and a bolt to be inserted through the X-ray tube mounting portion 23 is screwed into the female screw of the radiation port portion 13 to fasten and mount the X-ray tube 10 on the X-ray tube mounting portion 23.

The rotation mechanism 24 comprises a pair of bearing portions 32 provided on the installation stand 21, a pair of arms 33 mounted on the X-ray tube mounting portion 23, and a shaft member 34 that rotatably supports the arms 33 with respect to the bearing portions 32. The bearing portions 32 are fixed on the installation stand 21. The shaft member 34 is detachable from the bearing portion 32 in the axial direction and is prevented from rotating in the direction of rotation around the axis.

The rotation mechanism 24 rotatably supports the X-ray tube mounting portion 23 on the installation stand 21. In other words, the rotation mechanism 24 enables the X-ray tube mounting portion 23 to rotate around the shaft member 34 between a packing position (transport position), which is to be substantially perpendicular to the installation stand 21, and an installation position, which is to be substantially parallel to the installation stand 21 above the installation stand 21. The rotation mechanism 24 changes the X-ray tube 10 from a posture at the time of packing to a posture at the time of installation, which is different from the posture at the time of packing and is the posture at the time of placing the X-ray tube on the installation stand 21 after unpacking. Note that the rotation mechanism 24 is provided on the installation stand 21. In the packing position, the X-ray tube mounting portion 23 is substantially perpendicular to an upper surface (installation surface) 21a of the installation stand 21. In the installation position, the X-ray tube mounting portion 23 is substantially parallel to the upper surface 21a of the installation stand 21.

The rotation mechanism 24 is disposed on the installation stand 21 at a position closer to the opposite side with respect to the rotation direction of the X-ray tube mounting portion 23, setting the X-ray tube 10 to a posture at the time of installation, than to a central position on the installation stand 21 in a direction corresponding to the rotation direction of the X-ray tube mounting portion 23. Therefore, in the direction along the tube axis 12 of the tube container 11, the center of the installation stand 21 is located between the center of the X-ray tube 10 and the rotation mechanism 24.

The rotation prevention mechanism 25 has a mechanism part 36 provided in the rotation mechanism 24, an operation part 37 provided in the X-ray tube mounting portion 23, and an interlocking part 38 that interlocks these mechanism part 36 and operation part 37.

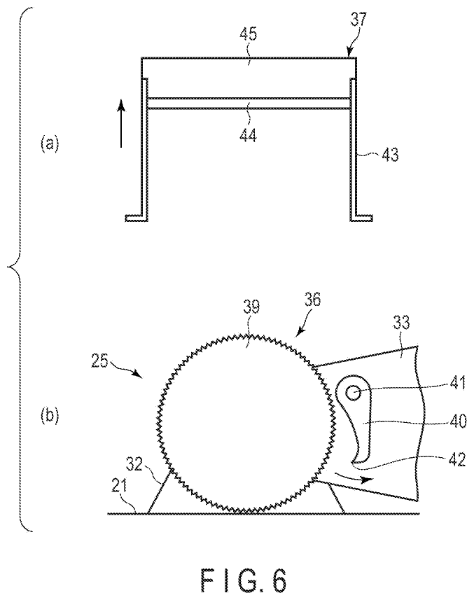

The mechanism part 36 has a gear 39 provided on the shaft member 34 and a claw member 40 provided on the arm 33. As shown in FIG. 5(b) and FIG. 6(b), the gear 39 has a plurality of teeth formed on its circumference. The gear 39 is fixed to the shaft member 34. By inserting the shaft member 34 into the bearing portion 32 through the arm 33, the gear 39 is disposed on the inner surface side of the arm 33 and is fixed to the bearing portion 32 via the shaft member 34. In other words, the gear 39 does not rotate with the bearing portion 32 and is fixedly disposed. Furthermore, the claw member 40 is disposed on the inner surface side of the arm 33 and is rotatably supported on the arm by a claw shaft 41. A claw portion 42 that meshes with the gear 39 is provided on the distal end side of the claw member 40. The claw member 40 is urged by an urging member (not shown) in the direction in which the claw portion 42 meshes with the gear 39.

As shown in FIG. 1, FIG. 5(a), and FIG. 6(a), the operation part 37 has a pair of handle members 43 attached to the upper part of the X-ray tube mounting portion 23, and an operation bar 44 provided on these handle members 43. The handle member 43 has a handle portion 45 that is gripped by an operator. The operation bar 44 is movably provided on the handle member 43 so as to approach or move away from the handle portion 45. It is possible for the operator to grip the operation bar 44 together with the handle portion 45. The operation bar 44 may be urged by an urging member in a direction away from the handle portion 45.

The interlocking part 38 is configured by, for example, a rod. The interlocking part 38 connects the claw member 40 and the operation bar 44, and interlocks the rotation of the claw member 40 with the movement of the operation bar 44.

The fixing portion 26 is configured by an substantially triangular-shaped plate. One side of the fixing portion 26 is fastened to the installation stand 21 by a bolt or the like, and the other side adjacent to this one side at a substantially right angle is fastened to the X-ray tube mounting portion 23 by a bolt or the like.

Next, the operation of the X-ray tube packing device 20 will be described.

In the X-ray tube 10, the tube axis 12 at the time of packing (during transportation) is in a vertical direction, and, from the viewpoint of mounting the X-ray tube 10 on a device of another party into which it is to be incorporated (for example, in the case of a medical X-ray tube device, a frame of a CT scanner, etc.), the tube axis 12 at the time of installation is in a horizontal direction. Therefore, after starting the work of mounting the X-ray tube 10 to the other party device, the tube axis 12 of the X-ray tube 10 is made substantially parallel to the upper surface 21a of the installation stand 21.

As shown in FIG. 1, when packing, the radiation port portion 13 of the X-ray tube 10 is fastened and fixed to the mounting base portion 30 of the X-ray tube mounting portion 23. At this time, the X-ray tube mounting portion 23 is positioned in the packing position substantially perpendicular to the upper surface of the installation stand 21, and a pair of fixing portions 26 are fastened and fixed to the installation stand 21 and the X-ray tube mounting portion 23, respectively. Furthermore, the claw member 40 of the rotation prevention mechanism 25 is in a state where it meshes with the gear 39, and the rotation of the X-ray tube mounting portion 23 is restricted with respect to the installation stand 21.

By mounting the X-ray tube 10 on the X-ray tube mounting portion 23, the tube axis 12 of the X-ray tube 10 is positioned along the vertical direction. After the X-ray tube 10 is mounted on the X-ray tube mounting portion 23, the X-ray tube 10 is covered with the outer packing portion 22 in a manner such that the entire tube is packed. The X-ray tube 10 is transported in this packed state by the X-ray tube packing device 20.

During transportation, a load path is formed to transmit the load relatively applied to the X-ray tube 10 from the outside due to impact, vibration, etc., in the order of the radiation port portion 13 of the tube container 11 of the X-ray tube 10, the X-ray tube mounting portion 23, the fixing portion 26, and the installation stand 21. This reduces the transmission of impacts, vibrations, etc., from the tube container 11 of the X-ray tube 10 to the components in this tube container 11.

After the X-ray tube 10 is transported to a predetermined installation site by the X-ray tube packing device 20, the X-ray tube packing device 20 is unpacked.

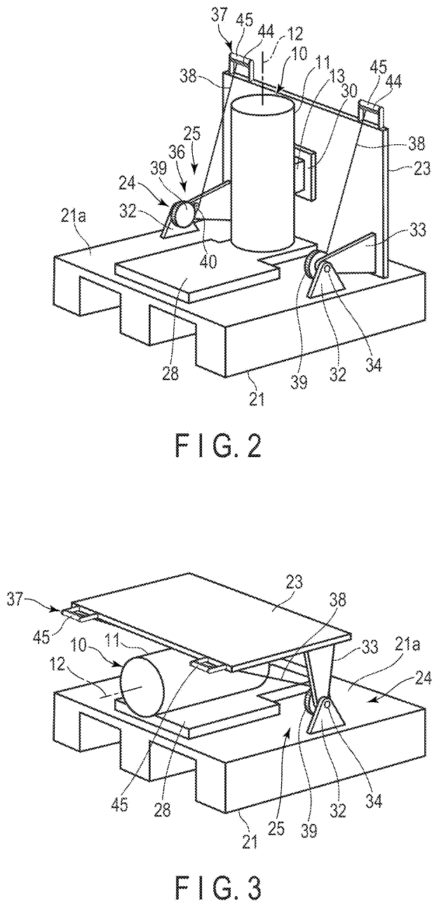

The operator removes the outer packing portion 22 and the pair of fixing portions 26, as shown in FIG. 2.

The operator grips the operation bar 44 together with the pair of handle portions 45 with both hands. This allows the claw member 40 to disengage from the meshed state with the gear 39 via the interlocking part 38, and allows the X-ray tube 10 and the X-ray tube mounting portion 23 to be rotated.

The operator, in the state of gripping the pair of handle portion 45 and operation bar 44 together with both hands, rotates the X-ray tube 10 and the X-ray tube mounting portion 23 in unison around the shaft member 34 of the rotation mechanism 24 so that the X-ray tube 10 is changed from the posture at the time of packing to the posture at the time of installation.

During this rotation operation, for example, in a case where a rapidly rotating force acts due to the influence of the positions of the center of gravity of the X-ray tube 10 and the X-ray tube mounting portion 23, by the operator stopping gripping the operation bar 44 together with the handle portion 45, the claw member 40 of the rotation prevention mechanism 25 meshes with the gear 39, and the rotation of the X-ray tube 10 and the X-ray tube mounting portion 23 stops. This prevents the X-ray tube 10 and the X-ray tube mounting portion 23 from rotating all the way to the installation position.

Then, as shown in FIG. 3, the X-ray tube 10 is changed from the posture at the time of packing to the posture at the time of installation by the rotation of the X-ray tube 10 and the X-ray tube mounting portion 23, and is placed on the installation portion 28 of the installation stand 21.

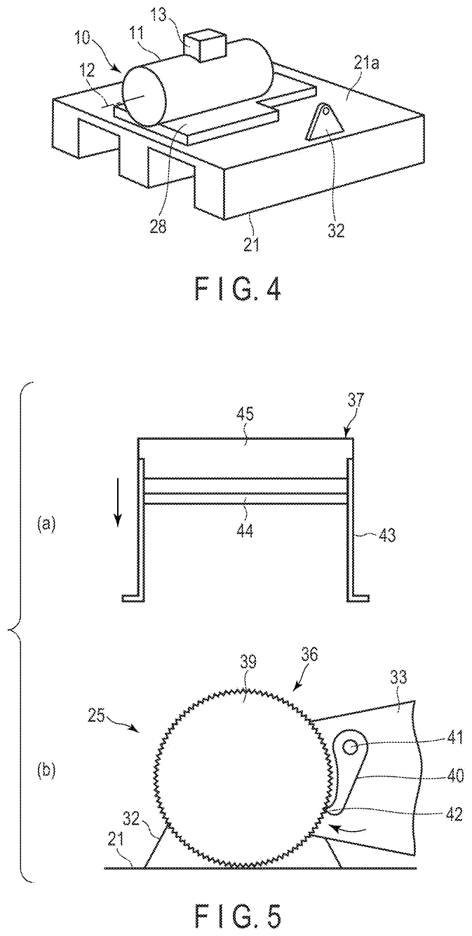

Subsequently, as shown in FIG. 4, the fastening between the X-ray tube 10 and the X-ray tube mounting portion 23 is released, and, together with the gear 39, the shaft member 34 is removed from the bearing portion 32 and the arm 33, leaving the bearing portion 32 on the installation stand 21, and removing the X-ray tube mounting portion 23, the rotation mechanism 24, the rotation prevention mechanism 25, and etc. Note that, when removing the rotation mechanism 24, the arm 33 and the shaft member 34 of the rotation mechanism 24 are removed.

The X-ray tube 10 is placed on the installation stand 21 in the posture at the time of installation, in which the tube axis 12 is horizontal.

Thus, according to the X-ray tube packing device 20, by using the rotation mechanism 24, the X-ray tube 10 can be changed from a posture at the time of packing to a posture at the time of installation, which is different from the posture at the time of packing and is the posture at the time of placing the X-ray tube on the installation stand 21 after unpacking. Therefore, the posture of the X-ray tube 10 after unpacking can be easily changed.

As a result, the burden on the operator can be reduced, and work can be performed with fewer people. In addition, the posture can be changed so that no load is applied to the X-ray tube 10, and the X-ray tube 10 can be prevented from being damaged or malfunctioning.

In addition, by providing the rotation prevention mechanism 25, the X-ray tube 10 can respond to unexpected rotation due to changes in the position of the center of gravity when changing the posture of the X-ray tube 10, and the posture of the X-ray tube 10 can be maintained at the rotation position during the transition from the posture during transportation to the posture during installation.

Furthermore, since the posture of the X-ray tube 10 during transportation is different from the posture during installation, the floor space of the X-ray tube packing device 20 may become larger. Therefore, the rotation mechanism 24 is disposed on the installation stand 21 at a position closer to the opposite side with respect to the rotation direction of the X-ray tube mounting portion 23, setting the X-ray tube 10 to a posture at the time of installation, than to the center position on the installation stand 21 in the direction corresponding to the rotation direction of the X-ray tube mounting portion 23. As a result, the size of the X-ray tube packing device 20 and the floor space can be reduced to minimum dimensions including the time of transportation and the time of installation.

Furthermore, if packing is performed by shifting the position of the X-ray tube 10 from the center of the X-ray tube packing device 20 during transportation, the strength/impact/vibration resistance to various loads applied to the X-ray tube 10 from outside during transportation may be weakened. Therefore, at the time of packing (during transportation), the fixing portion 26 is provided to fix the X-ray tube 10 to the installation stand 21. As a result, a load path is formed in which the relative load applied to the X-ray tube 10 from the outside due to impact, vibration, etc., is transmitted in the order of the radiation port portion 13 of the tube container 11 of the X-ray tube 10, the X-ray tube mounting portion 23, the fixing portion 26, and the installation stand 21. This allows the strength/impact/vibration resistance during transportation to improve.

Note that since the stopping position of the X-ray tube 10 and the X-ray tube mounting portion 23 depends on the angle of the circular pitch of the teeth of the gears 39, in the case where the stopping position is desired to be finely adjusted, this is possible by changing the circular pitch of the gears 39.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray tube packing device for packing an X-ray tube, comprising:
an installation stand;
an X-ray tube mounting portion for mounting the X-ray tube; and
a rotation mechanism that is provided on the installation stand, rotatably supports the X-ray tube mounding portion, and changes the X-ray tube from a posture at a time of packing to a posture at a time of installation, which is different from the posture at the time of packing and is the posture at the time of placing the X-ray tube on the installation stand after unpacking.

2. The X-ray tube packing device of claim 1, wherein the rotation mechanism is disposed on the installation stand at a position closer to an opposite side with respect to a rotation direction of the X-ray tube mounting portion, setting the X-ray tube to a posture at the time of installation, than to a center position on the installation stand in a direction corresponding to the rotation direction of the X-ray tube mounting portion.

3. The X-ray tube packing device of claim 1, comprising a rotation prevention mechanism that stops rotation of the X-ray tube mounting portion.

4. The X-ray tube packing device of claim 3, wherein the rotation mechanism is disposed on the installation stand at a position closer to an opposite side with respect to a rotation direction of the X-ray tube mounting portion, setting the X-ray tube to a posture at the time of installation, than to a center position on the installation stand in a direction corresponding to the rotation direction of the X-ray tube mounting portion.

5. The X-ray tube packing device of claim 1, further comprising a fixing portion that fixes the X-ray tube mounting portion to the installation stand at the time of packing.
